(19) United States
(12) Patent Application Publication
(10) Pub. No.: US 2017/0073190 A1
(43) Pub. Date: Mar. 16, 2017

(54) ACTUATOR ASSEMBLY FOR AN ELEVATOR GOVERNOR SYSTEM AND METHOD

(71) Applicant: OTIS ELEVATOR COMPANY, Farmington, CT (US)

(72) Inventor: Randall S. Dube, Glastonbury, CT (US)

(21) Appl. No.: 15/247,446

(22) Filed: Aug. 25, 2016

Related U.S. Application Data
(60) Provisional application No. 62/218,021, filed on Sep. 14, 2015.

(51) Int. Cl. B66B 5/16; B66B 5/04

(52) U.S. Cl. CPC B66B 5/16; B66B 5/044

(57) ABSTRACT

An actuator assembly for an elevator governor system includes a governor for detecting an overspeed condition. Also included is a safety linkage actuating lever operatively coupled to the governor. Further included is at least one safety operatively coupled to the safety linkage actuating lever and configured to apply a braking force during an overspeed condition. Yet further included is a permanent magnet latch engaged with the safety linkage actuating lever, the permanent magnet latch preventing actuation of the safety by the safety linkage actuating lever during a normal speed condition. Also included is an electromagnetic component disposed proximate the safety linkage actuating lever and the permanent magnet latch and in operative communication with the governor, the electromagnetic component in an energized condition during the overspeed condition to overcome a force applied by the permanent magnet latch to the safety linkage actuating lever to actuate the safety.

### CROSS-REFERENCE TO RELATED APPLICATION

This patent application claims priority to U.S. Provisional patent Application Ser. No. 62/218,021, filed Sep. 14, 2015, which is incorporated herein by reference in its entirety.

### FIELD OF THE DISCLOSURE

The subject matter disclosed herein relates generally to the field of elevators, and more particularly to speed governors for elevators.

### BACKGROUND OF THE DISCLOSURE

Typical elevator systems include a governor device to react to an overspeed condition of an elevator car or counterweight in a hoistway. The governor device may be indirectly connected to an elevator safety to slow and/or stop the movement of the elevator car in the case of an overspeed condition. Governor systems include a tensioned governor rope or belt connected to a safety linkage actuating lever on the elevator car and/or counterweight. Ideally, the safety linkage does not move unless a car or counterweight overspeed threshold is achieved and engagement of the safeties to decelerate the car and/or counterweight is needed. An emergency stop of the car and/or counterweight due to a variety of faults results in abrupt deceleration of the governor rope loop. This deceleration of rope loop inertia creates a force which must be resisted by some device, such as a releasing carrier, or the safety linkage will move and cause undesirable actuation of the car and/or counterweight safeties. In configurations with a stationary governor rope, an abrupt car (or counterweight) deceleration is directly transmitted to the safety linkage actuating lever. Devices that resist this force are difficult to implement effectively, can be expensive, require factory and/or field adjustment, and must be performance matched to the particular system they are installed in.

### BRIEF DESCRIPTION OF THE DISCLOSURE

According to one aspect of the disclosure, an actuator assembly for an elevator governor system is provided and includes a governor for detecting an overspeed condition. Also included is a safety linkage actuating lever operatively coupled to the governor. Further included is at least one safety operatively coupled to the safety linkage actuating lever and configured to apply a braking force during an overspeed condition. Yet further included is a permanent magnet latch engaged with the safety linkage actuating lever, the permanent magnet latch preventing actuation of the at least one safety by the safety linkage actuating lever during a normal speed condition. Also included is an electromagnetic component disposed proximate the safety linkage actuating lever and the permanent magnet latch and in operative communication with the governor, the electromagnetic component in an energized condition during the overspeed condition to overcome a force applied by the permanent magnet latch to the safety linkage actuating lever to actuate the at least one safety.

In addition to one or more of the features described above, or as an alternative, further embodiments may include that the electromagnetic component is electrically coupled to the governor.

In addition to one or more of the features described above, or as an alternative, further embodiments may include that the electromagnetic component is directly coupled to the governor with at least one wire.

In addition to one or more of the features described above, or as an alternative, further embodiments may include that the electromagnetic component is electrically coupled to the governor with a wireless connection.

In addition to one or more of the features described above, or as an alternative, further embodiments may include that the safety linkage actuating lever is operatively coupled to the governor with at least one cable.

In addition to one or more of the features described above, or as an alternative, further embodiments may include that the governor is electrically coupled to a controller.

In addition to one or more of the features described above, or as an alternative, further embodiments may include that the safety linkage actuating lever is electrically coupled to a controller.

In addition to one or more of the features described above, or as an alternative, further embodiments may include that the controller is in electrical communication with a back-up power supply.

In addition to one or more of the features described above, or as an alternative, further embodiments may include that the safety linkage actuating lever comprises a first actuating lever operatively coupled to a first safety, the actuator assembly further comprising a second actuating lever operatively coupled to a second safety, wherein the first actuating lever and the second actuating lever are located proximate a respective permanent magnet latch and electromagnetic component.

According to another aspect of the disclosure, a method of controlling an actuator assembly of an elevator governor system is provided. The method includes applying a force on a safety linkage actuating lever with a permanent magnet latch to prevent the safety linkage actuating lever from moving the safety linkage and actuating at least one safety during a normal speed condition. The method also includes energizing an electromagnetic component located proximate the permanent magnet latch and the safety linkage actuating lever to overcome the force applied by the permanent latch in response to an overspeed condition detected by a governor that the electromagnetic component is electrically coupled to.

In addition to one or more of the features described above, or as an alternative, further embodiments may include that the electromagnetic component is energized in response to an electrical signal generated by mechanical motion associated with a tripping action of the governor.

In addition to one or more of the features described above, or as an alternative, further embodiments may include electrically coupling the safety linkage actuating lever to a controller.

In addition to one or more of the features described above, or as an alternative, further embodiments may include electrically coupling the governor to a controller.

In addition to one or more of the features described above, or as an alternative, further embodiments may include that the controller is in electrical communication with a back-up power supply.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of an actuator assembly for an elevator governor system according to one aspect of the disclosure; and

FIG. 2 is a schematic illustration of the actuator assembly according to another aspect of the disclosure.

The detailed description explains embodiments of the disclosure, together with advantages and features, by way of example with reference to the drawings.

### DETAILED DESCRIPTION OF THE DISCLOSURE

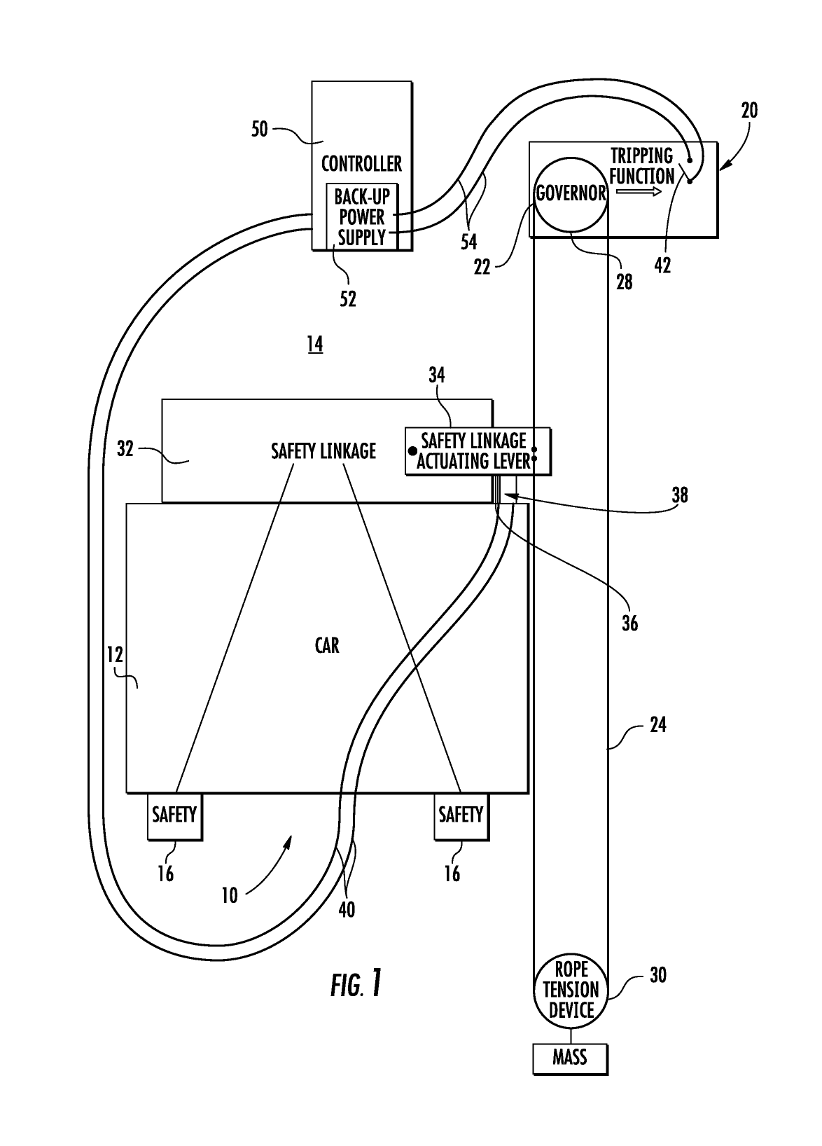

Referring to FIG. 1, illustrated is an elevator system 10 that includes an elevator car 12 operatively suspended or supported in a hoistway 14 with one or more suspension members (not shown), such as ropes or belts. The one or more suspension members interact with one or more sheaves to be routed around various components of the elevator system 10 in any known manner. The one or more sheaves could also be connected to a counterweight, which is used to help balance the elevator system 10 and reduce the difference in belt tension on both sides of a traction sheave during operation.

The elevator system 10 further includes one or more guide rails to guide the elevator car 12 along the hoistway 14. The elevator car 12 includes one or more guide shoes interactive with the guide rails to guide the elevator car 12, and also may include at least one safety 16 that is interactive with the guide rail to slow and/or stop motion of the elevator car 12 under certain conditions, such as an overspeed condition.

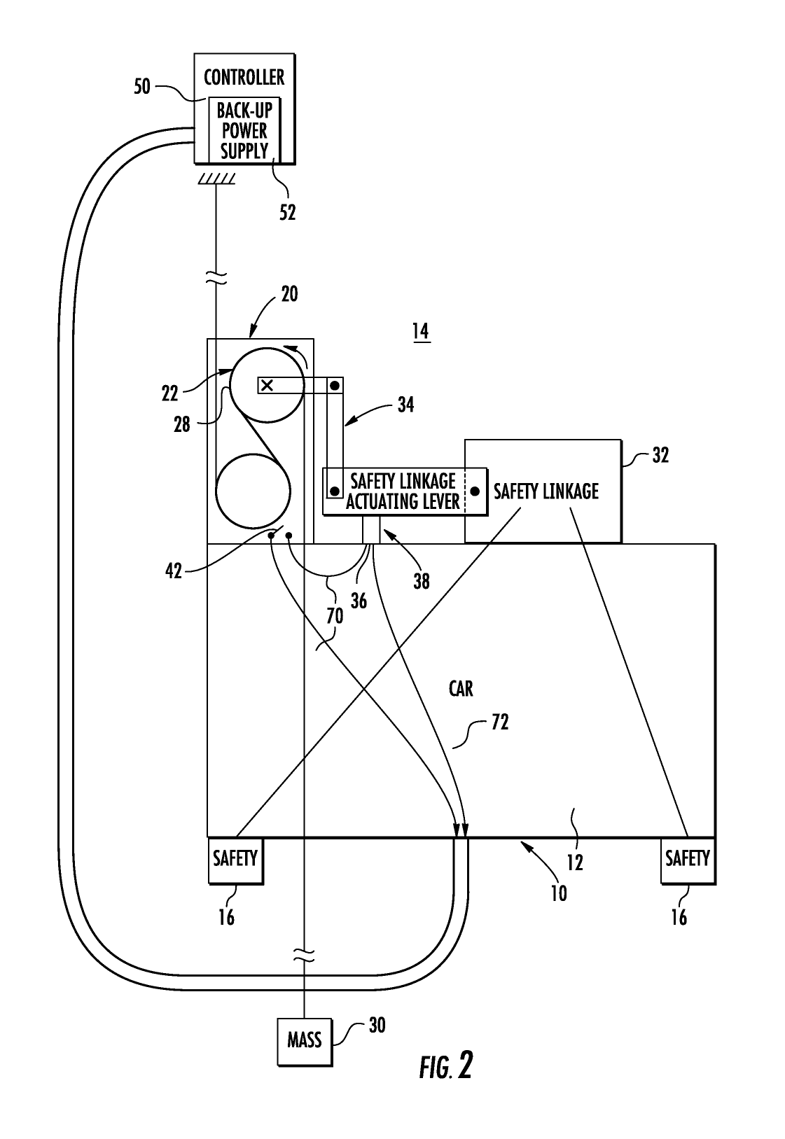

The elevator system 10 includes an elevator governor system 20, which comprises a governor mechanism 22 that is employed to monitor and detect an overspeed condition of the elevator car 12 and/or the counterweight. A governor cable 24 of the elevator governor system 20 is secured to the elevator car 12. The governor mechanism 22 includes an overspeed pulley 28 through which the governor cable 24 is routed. The governor cable 24 is engaged with the overspeed pulley 28 located at, a hoistway top, for example. Alternatively, the governor may be in the pit of the hoistway with an idler pulley at the top in some embodiments. The governor cable 24 is engaged with a cable tension device 30, such as a second pulley. In the car mounted governor configuration of FIG. 2, the governor cable 24 is tensioned with a spring or hanging mass. The overspeed pulley 28 and the cable tension device rotate about respective pulley axes as the elevator car 12 travels along the hoistway 14. In the car mounted governor configuration of FIG. 2, the two pulleys in the governor rotate as the car moves up and down and the governor cable remains stationary.

The rotation is driven by the passage of the governor cable 24 around the pulleys while the elevator car 12 is in motion. The governor cable 24 is operatively coupled to the at least one safety 16 via, for example, a safety linkage 32. The safety linkage 32 is operatively coupled to a safety linkage actuating lever 34 which is operatively coupled to the governor cable 24. The safety linkage actuating lever 34 of FIG. 2 is operatively coupled to a rotatable ring designed to desirably move the safety linkage actuating lever 34 in response to an overspeed condition. When the overspeed pulley 28 rotates at a speed equal to or greater than a selected threshold speed, it is indicative of an overspeed condition in movement of the elevator car 12 along the hoistway 14. If the speed of the overspeed pulley 28 is equal to or greater than the threshold speed, the governor mechanism 22 reacts to engage governor elements that increase tension in the governor cable 24 to impart a force on the safety linkage actuating lever 34 that is operatively coupled thereto. During normal speed conditions, defined as a speed less than the threshold speed selected as an overspeed condition, it is possible that the tension in the governor cable 24 or forces from other system disturbances may “trip” the safety linkage actuating lever 34, resulting in unnecessary braking of the elevator car 12 with the at least one safety 16.

To avoid inadvertent tripping of the safety linkage 32, the embodiments described herein provide an actuation assembly that ensures reliable tripping of the safety linkage actuating lever 34. A permanent magnet latch 36 is engaged with the safety linkage actuating lever 34 in a manner that imparts a force on the actuating lever 34 that reliably prevents the actuating lever 34 from moving to an extent that would trip the safety linkage 32. The latching force imparted by the permanent magnet latch 36 is greater than any forces that may attempt to move the actuating lever 34, prior to an overspeed threshold, including tensions generated in the governor cable 24 that is coupled to the actuating lever 34.

The actuation assembly also includes an electromagnetic component 38 that is disposed proximate the permanent magnet latch 36 and the actuating lever 34. In some embodiments, the electromagnetic component 38 is integral with the permanent magnet latch 36. The electromagnetic component 38 is in a de-energized state during normal speed conditions of the elevator car 12, thereby allowing the permanent magnet latch 36 to uninterruptedly apply the latching force to the actuating lever 34. The electromagnetic component 38 is electrically connected to the governor mechanism 22 via one or more wires 40. Two wires 40 are shown to represent a dual wiring scheme with one wire being for power and another for a return in a DC circuit, but it is to be appreciated that a single wire or more than two wires may be employed. Although direct connection of wire(s) may be made with the governor mechanism 22, as shown in the illustrated embodiment, the wire(s) are connected to a controller 50 that receives data associated with the overall elevator assembly 10, including the governor system 20 and actuation system, and to communicate with components to perform specific functions. The controller 50 includes a back-up power supply 52 in some embodiments to ensure functionality in the event of a power outage. The controller 50 is in electrical communication via one or more wires 54 with the governor mechanism 22.

An electrical signal is generated immediately upon detection of a tripping of one or more mechanical elements of the governor mechanism 22. For example, a mechanical element of the governor mechanism 22 is engaged with a component that trips a switch 42 that is electrically connected to the electromagnetic component 38. Upon receipt of the electrical signal, either from the governor mechanism 22 directly or via the controller 50, the electromagnetic component 38 enters an energized state that will cancel the flux of the permanent magnet, eliminating its holding force and thereby releasing the latch and allowing the safety linkage actuating lever 34 to be tripped by the governor cable 24, or ring, thereby tripping the safety linkage 32 and actuating the at least one safety 16. Furthermore, as long as the electrical signal (e.g., power) is at a full required magnitude (continuous or it could be a pulse to short the PM flux initially), or some necessary residual percentage thereof is applied (e.g., via the controller power supply), the holding force is eliminated and the safety actuating lever is free to move. The freedom to move would cover the span of time for the car to be decelerated by the safeties to a stop and until the governor is reset. Automatic resetting of the safeties by moving the elevator car up (standard procedure) resets the governor mechanical elements (in a multi-car ropeless system) which previously caused the electrical signal to be generated and thus opens the circuit again and re-activates the permanent magnet latch/holding force. If the governor requires manual resetting, the mechanic that initiates car motion for the safeties automatic resetting would also reset the governor immediately thereafter before returning the car back to normal operation. This scenario demonstrates the need that only a small current is necessarily required to maintain no holding force applied, but perhaps a larger magnitude signal (again maybe a pulse) is needed initially to eliminate the holding force. Otherwise, some time-out might be needed to prevent higher power from being on for hours until a mechanic shows up. This illustrates some of the advantages of the embodiments described herein.

Although described above as a hard wired electrical connection between the electromagnetic component 38 and the governor mechanism 22, it is to be appreciated that a wireless connection may be made between the electromagnetic component 38 and the governor mechanism 22.

In the illustrated embodiment, a single safety linkage actuating lever is depicted, however, it is to be appreciated that a plurality of actuating levers may be included and may independently control respective safety linkages and/or safeties. For example, one embodiment includes a first actuating lever operatively coupled to a first safety and a second actuating lever operatively coupled to a second safety, wherein the first actuating lever and the second actuating lever are located proximate respective permanent magnet latches and electromagnetic components.

FIG. 2 illustrates another aspect of the disclosure. In particular, the schematic illustration of FIG. 2 illustrates a system with an elevator governor system 20 with a fixed governor rope 24 and an alternate wiring scheme. The embodiment illustrated in FIG. 2 is similar in many respects to the embodiment illustrated in FIG. 1 and corresponding reference numerals have been employed to represent similar components. The electromagnetic component 38 is electrically connected to the governor mechanism 22 with a wire 70 and on to the controller 50. A second wire 72 is routed from the electromagnetic component 38 to the controller 50 for redundancy purposes.

Advantageously, the embodiments of the actuation assembly described herein eliminate undesirable movements of the safety linkage 32 due to car and/or counterweight emergency stops, which may lead to inadvertent actuating of the safeties. Additional actions that may lead to inadvertent actuating include a system disturbance (e.g., people rhythmically bouncing a car) or vandalism, for example. Additionally, prior efforts directed at mechanically matching the forces to be applied to counteract movement, such as done by releasing carriers, result in costly and numerous designs. The embodiments described herein avoid the need to uniquely adjust releasing carriers in the factory and/or field. These advantages are achieved by electrically connecting the electromagnetic component 38 to elements of the governor mechanism 22 that reliably indicate mechanical motion associated with an actual overspeed condition that necessitates tripping of the safety linkage 32, thereby avoiding requiring reliance on the governor cable itself.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. An actuator assembly for an elevator governor system comprising:
a governor for detecting an overspeed condition;
a safety linkage actuating lever operatively coupled to the governor;
at least one safety operatively coupled to the safety linkage actuating lever and configured to apply a braking force during an overspeed condition;
a permanent magnet latch engaged with the safety linkage actuating lever, the permanent magnet latch preventing actuation of the at least one safety by the safety linkage actuating lever during a normal speed condition; and
an electromagnetic component disposed proximate the safety linkage actuating lever and the permanent magnet latch and in operative communication with the governor, the electromagnetic component in an energized condition during the overspeed condition to overcome a force applied by the permanent magnet latch to the safety linkage actuating lever to actuate the at least one safety.

2. The actuator assembly of claim 1, wherein the electromagnetic component is electrically coupled to the governor.

3. The actuator assembly of claim 1, wherein the electromagnetic component is directly coupled to the governor with at least one wire.

4. The actuator assembly of claim 2, wherein the electromagnetic component is electrically coupled to the governor with a wireless connection.

5. The actuator assembly of claim 1, wherein the safety linkage actuating lever is operatively coupled to the governor with at least one cable.

6. The actuator assembly of claim 1, wherein the governor is electrically coupled to a controller.

7. The actuator assembly of claim 1, wherein the safety linkage actuating lever is electrically coupled to a controller.

8. The actuator assembly of claim 7, wherein the controller is in electrical communication with a back-up power supply.

9. The actuator assembly of claim 1, wherein the safety linkage actuating lever comprises a first actuating lever operatively coupled to a first safety, the actuator assembly further comprising a second actuating lever operatively coupled to a second safety, wherein the first actuating lever and the second actuating lever are located proximate a respective permanent magnet latch and electromagnetic component.

10. A method of controlling an actuator assembly of an elevator governor system comprising:
applying a force on a safety linkage actuating lever with a permanent magnet latch to prevent the safety linkage actuating lever from moving the safety linkage and actuating at least one safety during a normal speed condition; and
energizing an electromagnetic component located proximate the permanent magnet latch and the safety linkage actuating lever to overcome the force applied by the permanent latch in response to an overspeed condition detected by a governor that the electromagnetic component is electrically coupled to.

11. The method of claim 10, wherein the electromagnetic component is energized in response to an electrical signal generated by mechanical motion associated with a tripping action of the governor.

12. The method of claim 10, further comprising electrically coupling the safety linkage actuating lever to a controller.

13. The method of any of claims 10, further comprising electrically coupling the governor to a controller.

14. The method of claim 12, wherein the controller is in electrical communication with a back-up power supply.
